(19) United States
(12) Patent Application Publication
(10) Pub. No.: US 2024/0405453 A1
(43) Pub. Date: Dec. 5, 2024

(54) SPE PLUG-IN CONNECTOR

(71) Applicant: Weidmüller Interface GmbH & Co. KG, Detmold (DE)

(72) Inventors: Simon Seereiner, Bielefeld (DE); Benedikt Steube, Löhne (DE); Klaus Leuchs, Much (DE)

(21) Appl. No.: 18/679,398

(22) Filed: May 30, 2024

(30) Foreign Application Priority Data
Jun. 1, 2023 (DE) 102023114465.0

(51) Int. Cl. H01R 4/2425; H01R 13/58

(52) U.S. Cl. CPC H01R 4/2425; H01R 13/5812

(57) ABSTRACT

An SPE plug-in connector includes a housing, a plug-in face, a contact assembly, and a connection side. The plug-in face is formed on one side of the housing having two plug-in contacts and preferably a shielding collar. The contact assembly is provided in the housing and has at least four IDC contacts. Two of the IDC contacts are connected to one of the tow plug-in connectors and the other two of the IDC contacts are connected to the other of the two plug-in contacts. The connection side is on a different side of the housing for the connection of two cable ends of SPE cables to the IDC contacts of the contact assembly. Two first conductors of the first and the second SPE cables are respectively conductively connectable, via the contact assembly, to one another and to the first of the two plug-in contacts, and two second conductors of the first and second SPE cables are respectively conductively connectable, via the contact assembly, to one another and to the first of the two plug-in contacts, such that overall a T or Y branch can be realized with regard to the two cables.

This application claims priority of DE 102023114465.0 filed on Jun. 1, 2023, the entire content of which is incorporated herein by reference.

### BACKGROUND OF THE INVENTION

The invention relates generally to an SPE plug-in connector.

A transmission according to the Single Pair Ethernet (SPE) standard enables the transmission of data and energy via Ethernet lines with only a single twisted pair of wires. Cables for SPE thus consist of only two wires for the transmission of signals and energy, with it being possible to provide a common cable shield.

As a rule, a point-to-point connection is constructed. However, if switch functionality is built into a device, line topologies can also be constructed. These allow the devices to be arranged in a line or even a ring.

With such topologies, it is desirable for the associated Ethernet line to receive at least one branch without an active component, making it possible for a device to communicate with several other devices simultaneously (also known as a T or Y branch).

T or Y branches are typically not created in a structurally simple manner, and thus there is a need for an SPE connector that provides this.

### SUMMARY OF THE DISCLOSURE

According, it is an object of the present disclosure to provide an SPE plug-in connector which includes a housing, a plug-in face, a contact assembly, and a connection side. The plug-in face is formed on one side of the housing having two plug-in contacts and preferably a shielding collar. The contact assembly is provided in the housing and has at least four insulation displacement contact (IDC) contacts. Two of the IDC contacts are connected to one of the tow plug-in connectors and the other two of the IDC contacts are connected to the other of the two plug-in contacts. The connection side is on a different side of the housing for the connection of two cable ends of SPE cables to the IDC contacts of the contact assembly. Two first conductors of the first and the second SPE cables are respectively conductively connectable, via the contact assembly, to one another and to the first of the two plug-in contacts, and two second conductors of the first and second SPE cables are respectively conductively connectable, via the contact assembly, to one another and to the first of the two plug-in contacts, such that overall a T or Y branch can be realized with regard to the two cables.

In this manner, a type of T or Y branch on an SPE cable can be subsequently achieved, in particular by cutting through it. Alternatively, it is also possible to realize such a connection with separate cable elements which have not been cut through. Overall, with a number of such plug-in connectors arranged one behind the other on an SPE cable, a series arrangement of electrical devices on an SPE cable can be arranged if they are each provided with a corresponding mating plug-in connector.

In one embodiment, the housing has a disc-like design, so that it can be stacked together with other SPE plug-in connectors of a disc-shape construction.

Preferably the connection side is arranged on the side of the housing which faces away from the plug-in side. The two cable ends are guided into the housing preferably in parallel at this connection side.

In a separate embodiment, a plug-in connector is created, with in particular a T-like or Y-like branch that is realized subsequently on a single, continuous SPE cable.

This plug-in connector includes a housing, a plug-in face, a contact assembly, and a cable bushing. The plug-in face is formed on one side of the housing having two plug-in contacts and preferably a shielding collar. The contact assembly is provided in the housing and has at least two IDC contacts. One IDC contact is connected to one of the plug-in contacts and the other IDC contact is connected to the other. The cable bushing goes through the housing in a region at which at least one stripped region of a continuous SPE cable is guided through the housing (so that it runs in the housing). The conductors of the SPE cable can be contacted in the housing by the IDC contacts of the contact assembly, wherein the type of connection is such that the first of the two conductors of the SPE cable is connectable to the first of the two plug-in contacts and the second conductor of the SPE cable is connectable to the second of the two plug-in contacts. Overall, a T or Y branch can be realized with regard to the SPE cable.

Preferably the housing of this embodiment has a T or Y-shaped design. The cable bushing goes through the cross-limb of the T-shaped housing and the plug-in side with the plug-in face is formed in the base limb of the housing.

According to a further embodiment, the housing has one or more tension relief unit for the two cable ends of the two cables.

Furthermore, the tension relief units can each include a pivotable clip element having a locking hook for locking onto the housing.

In yet another embodiment, the housing has two housing halves, wherein the contact assembly is arranged in one housing part and wherein a cable manager, with which the conductors can be pushed into the respective IDC contacts when joining the two housing parts, is arranged in the other housing part.

### BRIEF DESCRIPTION OF THE DRAWINGS

The invention is described in greater detail hereinafter with reference to the drawings by means of exemplary embodiments. These show particularly advantageous configurations of the invention, but without the invention and the scope of protection of the claims not being limited thereto. Rather, alternatives and equivalents of the exemplary embodiments depicted can also be realized within the framework of the invention and the scope of protection. In the drawings:

FIG. 1a is a top view a first SPE plug-in connector;

FIG. 1b is a side view of the SPE plug-in connector of FIG. 1a;

FIG. 1c is a perspective view of the SPE plug-in connector of FIG. 1a;

FIG. 2a is a top view of two separated halves of the SPE plug-in connector of FIG. 1a;

FIG. 2b is a perspective view of the separated SPE plug-in connector of FIG. 2a;

FIGS. 3a, 3b and 3c are sectional views of housings and cables which illustrate the construction of a tension-relief function at the SPE plug-in connector housing:

FIG. 4a is a top view of a housing half metal assembly made up of plug-in face contacts, busbars and IDC contacts:

FIG. 4b is a top view of the housing half of FIG. 4a wherein two cables are applied to the housing half of the SPE plug-in connector

FIG. 4c is a top view of the housing half of FIG. 4b with a shielding collar of the SPE plug-in connector; and

FIG. 5a is a side view of a second embodiment of an SPE plug-in connector.

FIG. 5b is a front view of the SPE plug-in connector of FIG. 5a;

FIG. 5c is a top view of the SPE plug-in connector of FIG. 5a; and

FIG. 5d is a perspective view of the SPE plug-in connector of FIG. 5a.

### DETAILED DESCRIPTION

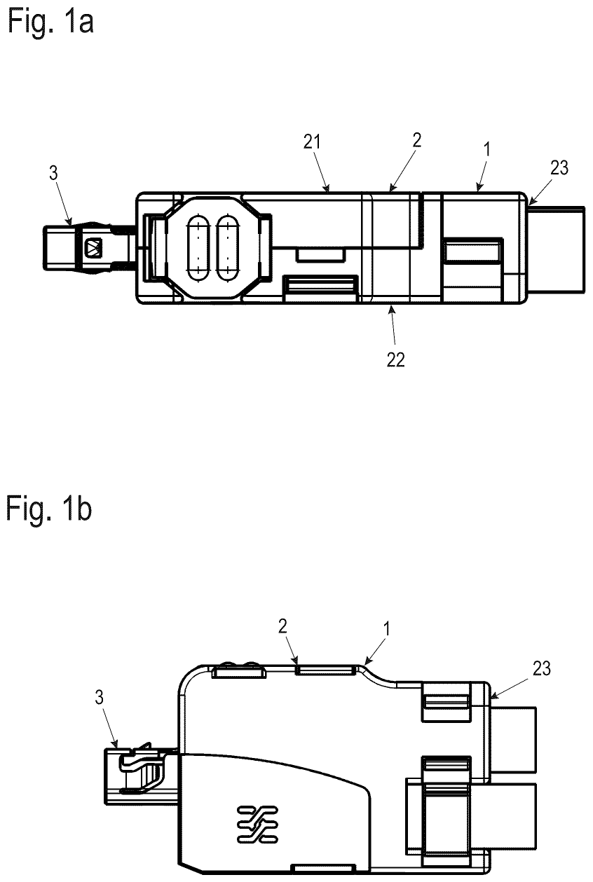

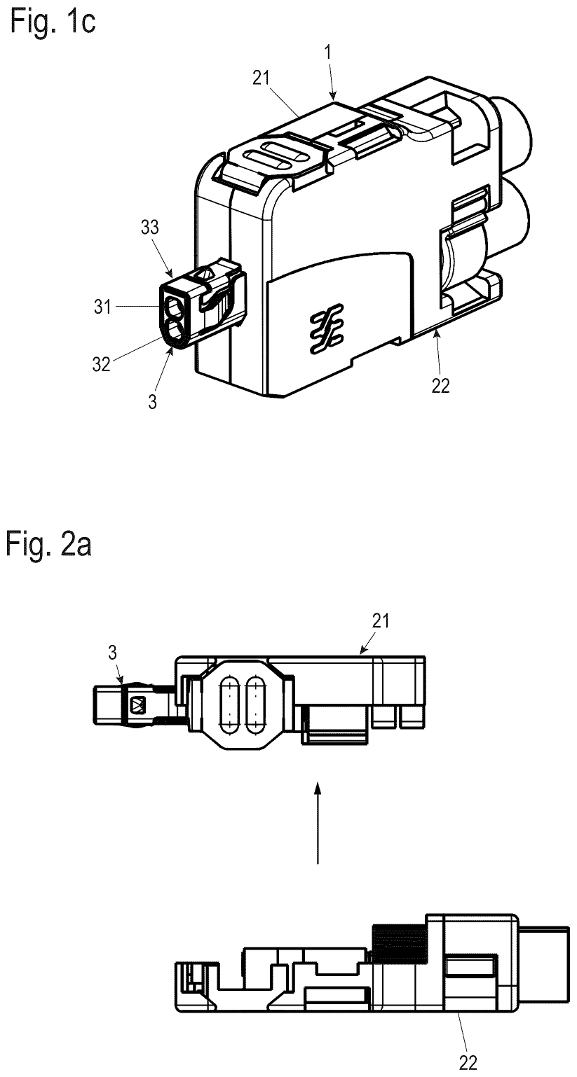

FIGS. 1a-4c and FIGS. 5a-5d show first and second embodiments, respectively, of a plug-in connector 1 for connecting with a corresponding, second plug-in connector (not depicted here) which is preferably on an electrical device.

The plug-in connectors are SPE plug-in connectors which can provide a T or Y branch to an SPE line or to an SPE cable 7. The SPE cable 7 has two twisted conductors 71, 72 which are each equipped with insulation, and which are enveloped at least by a cable shield 73 and a cable sheath 74.

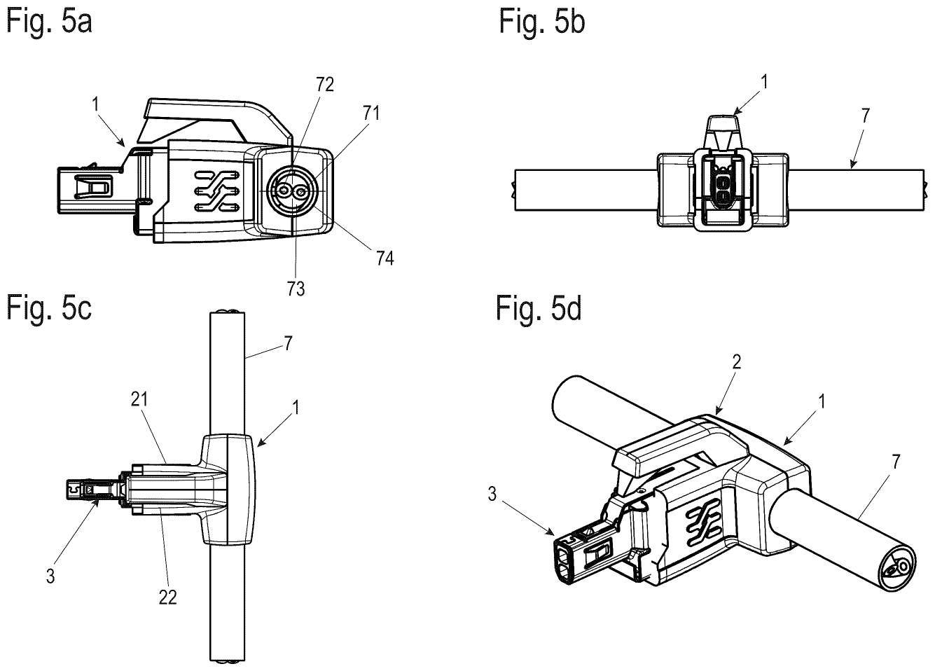

The SPE plug-in connectors 1 from FIGS. 1a-4a and from FIGS. 5a-5d each, similar to a “Multidrop System”, make it possible for the arrangement of devices to be connected via SPEs in a line or in a ring.

The SPE plug-in connectors 1 from FIGS. 1a-4c and from FIGS. 5a-5d each have a housing 2. Each housing 2 has a plug-in face 3 on one side with which the respective plug-in connector 1 can be plugged together with a corresponding SPE plug-in connector at or to an electrical device (not depicted here).

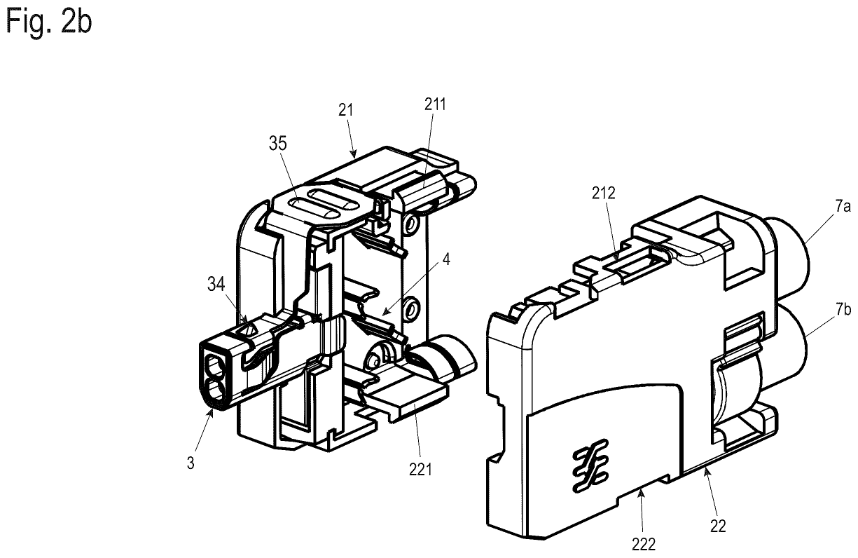

The plug-in face 3 of the SPE plug-in connector 1 in each case includes two plug-in contacts 31, 32 and a shielding collar 33 or shielding contact which includes the two plug-in contacts 31, 32 (see FIG. 1c and FIG. 5d, for example). In the region of the shielding collar 33, there is a locking hook 34 which can be moved, or actuated, by an actuator 35 (in this case an actuation lug) (see FIG. 2b) and which is used to lock onto a corresponding locking means of a mating plug-in connector, such as on a device.

The housing 2 of the plug-in connector 1 from FIGS. 1a to 4c are flat, having two main sides and four narrow sides, resulting in a substantially disc-shaped construction. The housings 2 are preferably made of a non-conductive plastic.

In the embodiment shown according to FIGS. 1a to 4c, the width of the narrow sides is 7.5 mm and the height of the main sides is 17.7 mm. The height-to-width ratio of the plug-in connector 1 is therefore preferably in the range between 2:1 and 3:1. The plug-in connector 1 claimed here is therefore not significantly wider than a standard plug-in connector of the same plug-in face.

The housings of each of the plug-in connectors disclosed here have two housing halves 21, 22. These can be locked onto one another via corresponding locking mechanisms 211, 212, 221, 222. This is advantageous for assembly. Alternatively, housings could be developed with only one or with more than two housing parts 21, 22.

According to FIGS. 1a to 4c, the splitting plane between the housing parts 21, 22 is substantially provided in the region of the narrow sides of the housings 2 so that two disc-type housing parts 21, 22 are created to facilitate mounting of additional components.

Referring again to FIGS. 1a to 4c and FIGS. 5a to 5d, one contact assembly 4 in each case is arranged in the housings 2.

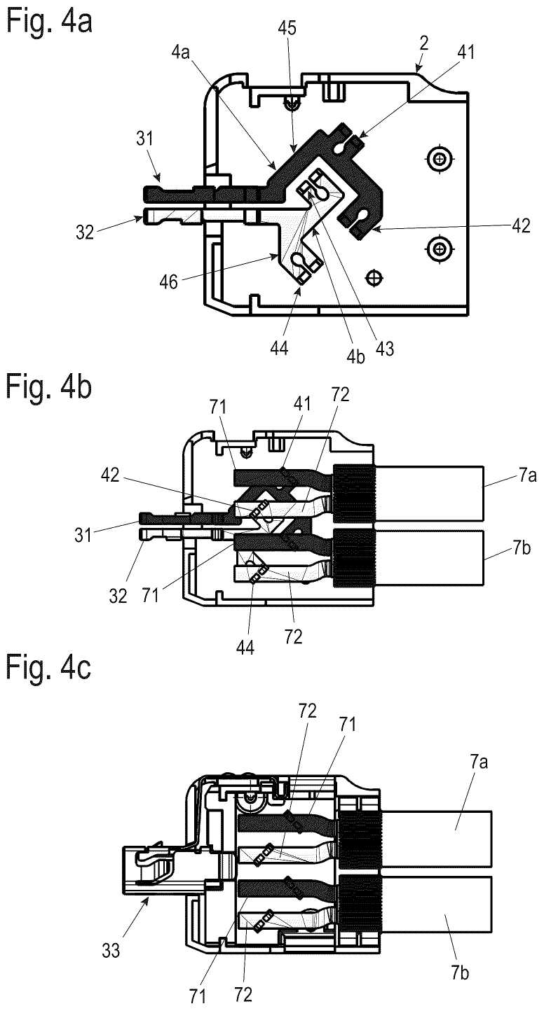

According to FIGS. 1a to 4c, the contact assembly includes at least four iDC contacts 41, 42; 43, 44 and two busbar sections 45, 46 (see FIGS. 4a, 4b, 4c). The two busbar sections 45, 46 are each connected to one of the plug-in contacts 31, 32 and each connected to two of the IDC contacts 41, 42 or 43, 44. The contact assembly 4 is thus or thereby split into two sections 4a, 4b which are not electrically conductively connected to each other. The contact assembly can essentially be provided in one of the two housing parts 21. The elements of the contact assembly 4 can be arranged directly in the housing or, for example, on a carrier element such as a circuit board, which is inserted into the housing 2.

The IDC contacts 41, 42, 43, 44 can also be configured as Insulation Piercing Contact (IPC) contacts. There are also referred to herein as an IDC contact.

It is advantageous for the cable or the two cable ends to be contacted to be pre-mounted on the other housing part 22, so that when the two cables are put together, their conductors are contacted by the IDC contacts 41, 42; 43, 44. The insulation-piercing contacts pierce the respective conductor insulation and the IDC contacts 41, 42; 43, 44 then contact the conductor wires of the conductors to be contacted. Such IDC contacts 41, 42; 43, 44 are known per se and therefore do not require a more detailed description.

The housing 2 also has at least one connection side 23 (FIGS. 1a, 1b, FIG. 5a-5d).

The connection side 23 of the housing of the plug-in connector from FIGS. 1a to 4c is advantageously on the side of the housing 2 facing away from the plug-in face 3.

The connection side 23 of the housing 2 has one or more openings 24 through which two SPE cable ends 7a, 7b can be fed into the interior of the housing 2 up to the region of the contact assembly 4 with the IDC contacts 41, 42; 43, 44.

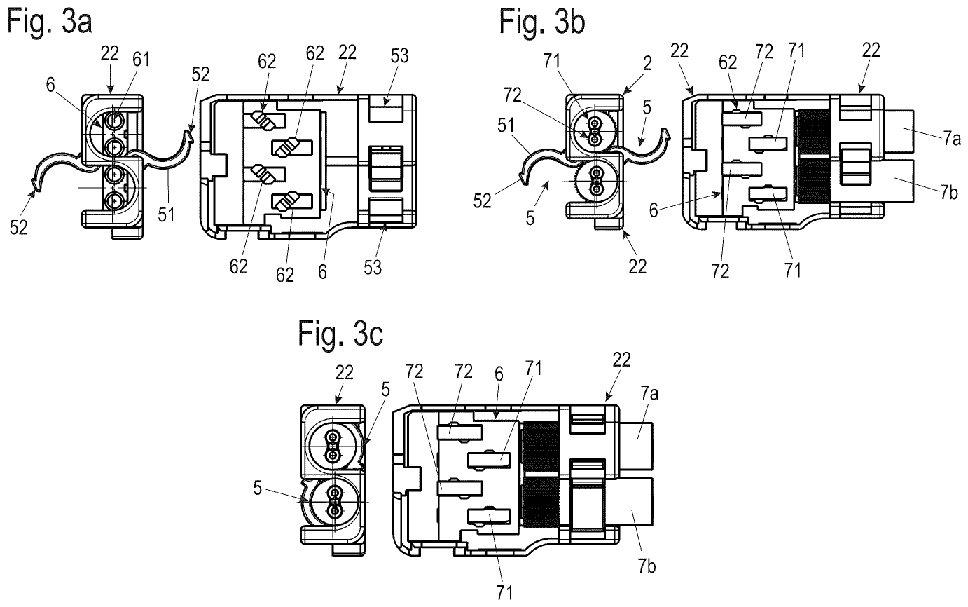

The two cable ends 7a, 7b can be fixed to the housing 2 with a tension relief device 5 (see also FIGS. 3a-3c). The tension relief device 5 can include a clip element 51, which is curved and pivotably attached to the housing 2 at one end. The other end of the clip element 51 can have a locking mechanism such as a locking hook 52, which can be fixed on a corresponding locking mechanism such as a locking recess 53 of the housing 2. When the cable end is inserted into the one housing part 22, the clip element 51 is pivoted into an open position. The cable end is then inserted and the clip element 51 is locked onto the housing part 22. The dimensioning and design are such that the respective cable end 7a or 7b is fixed onto the housing 2 very securely, with good tension relief.

The cable shield 73 and the cable sheath 74 are removed from each of the two cable ends 7a, 7b, preferably in a final end area, before insertion into the housing 2 (FIGS. 1a to 4c). This respective end regions are located in the housing 2 in the direction of the plug-in face 3 behind the two tension relief units 5.

In contrast, the plug-in connector 1 of FIG. 5a-5d is intended to contact a continuous SPE cable 7. The cable shield and cable sheath have been removed from the SPE cable in sections in a contact area away from the two ends of the continuous SPE cable.

As shown in FIGS. 1a-5d, the two SPE cable ends 7a, 7b can be inserted into the housing 2 in a particularly advantageous arrangement parallel to each other on one of the narrow sides at openings and can be fixed to the tension relief units.

Two conductors 71, 72 are secured in position in the one housing part 22 in such a way that when the two housing parts 21 and 22 are joined together, the conductors 71, 72 with the bearing elements 72 are pushed precisely into the IDC contacts 41, 42; 43, 44 respectively assigned to them. The conductors include conductor wire(s) and surrounding conductor insulation having a cable manager 6 with through-holes 61 and bearing elements 62 for the conductors 71, 72.

One conductor 71 is connected to one section 4a of the metal assembly and the other two conductors 72 are connected to the other section 4b of the metal assembly. To do this, the respective conductors 71, 72 are pushed into respective IDC contacts 41, 42; 43, 44.

In this way, a T or Y branch is realized in a very simple and compact manner in relation to the two cables 7a, 7b. A conductive connection to the conductors 71 and 72 of the two cables 7a, 7b is created at the plug-in contacts 31, 32, so that a T-branch or a Y-branch can be created on a continuous ‘SPE line’.

The plug-in connector 7 is thus constructed as an SPE plug-in connector with which a T or Y branch can be realized on an SPE cable 7. Here, in accordance with FIGS. 1a to 4c, a particularly flat, stackable plug-in connector 7 is created which, due to its disc-like design, can be easily inserted into a row of other plug-in connectors 7.

However, to have a Y or T branch on the SPE cable 7 for this purpose, the cable sheath 74 and the cable shield 73 on the continuous SPE cable 7 are removed in sections according to the exemplary embodiment shown in FIGS. 5a-5d. The two conductors 71, 72 are each contacted with a connection contact, preferably an IDC contact (not shown here). Since each of the two connection contacts is connected to one of the plug-in contacts of the plug-in connector, the desired T or Y arrangement can be easily achieved. However, the housing itself has a kind of T-shaped geometry. It is therefore not quite as flat as the exemplary embodiment in FIGS. 1a to 4c. However, it is advantageous that two cable ends are not contacted and a continuous SPE cable 7 is only stripped in one area. Therefore, the branch can be positioned anywhere.

The T-shaped housing from FIGS. 5a-5d, which could also have a Y shape, has a cable bushing. This goes through the housing 2, in the region of which at least one stripped region of a continuous SPE cable can be guided through the housing. The two conductors can thus be contacted in the housing by the IDC contacts of the contact assembly. The type of connection is such that the first of the two conductors of the SPE cable is connectable to the first of the two plug-in contacts and that the second conductor of the SPE cable is connectable to the second of the two plug-in contacts. This results in achieving a T or Y branch with regard to the SPE cable.

Conversely, as shown in FIGS. 1a to 4c, the SPE cable 7 is cut through at any point or two cables are provided and then, with the aid of the plug-in connector 1, a branch is realized in the region of the two cable ends 7a, 7b. The SPE plug-in connector of FIGS. 1a to 4c is more advantageous in terms of compactness. This is because the corresponding two conductors 71, 72 of two SPE cable ends 7a, 7b are conductively connected to each other via the plug-in connector. These two conductors being connected via the plug-in connector are also each connected to one of the plug-in contacts 31, 32 of the SPE plug-in connector 1.

The cable shields can each be connected to the shielding collar 33, which is not shown here.

The plug-in connectors 1 from FIGS. 1a and 5d can be placed as required for a particular application.

This results in a simple connection technique for T1-S multidrop applications and AUTBUS multidrop in particular.

A signal will always go through the plug-in connector 1. In each case it is advantageously possible to connect Ethernet-based devices in series, with the option of removing devices without interrupting the data stream.

It is also conceivable to have the plug-in connector with or without a circuit board.

The cable can also run at an angle to the plug-in face, for example at 45 degrees or 180 degrees.

Although the above description references particular embodiments, it is to be understood that these embodiments are merely illustrative of the principles and applications of the present disclosure. It is therefore to be understood that numerous modifications may be made to the illustrative embodiments and that other arrangements may be devised and employed without departing from the spirit and scope of the present disclosure.

What is claimed:

1. An SPE plug-in connector comprising:
(a) a housing;
(b) a plug-in face arranged on a first side of the housing having two plug-in contacts and optionally a shielding collar;
(c) a contact assembly arranged in the housing and having at least four IDC contacts, each of the plug-in contacts having two IDC contacts connected therewith; and
(d) a connection side arranged on a second side of the housing for connection of two cable ends of SPE cables to the IDC contacts of the contact assembly, wherein two first conductors of the first and the second SPE cables are respectively conductively connectable to one another via the contact assembly and to the first of the two plug-in contacts and two second conductors of the first and second SPE cables are respectively conductively connectable to one another via the contact assembly and to the second of the two plug-in contacts, a T or Y branch being provided with regard to the two cables.

2. The SPE plug-in connector according to claim 1, wherein the housing has a disc-like configuration.

3. The SPE plug-in connector according to claim 1, wherein the connection side is arranged on a side of the housing facing away from the plug-in side and two cable ends are guided into the housing at the connection side.

4. The SPE plug-in connector according to claim 3, wherein the cable ends are guided into the housing in parallel.

5. An SPE plug-in connector comprising:
(a) a housing,
(b) a plug-in face arranged on a first side of the housing having two plug-in contacts and optionally a shielding collar;
(c) a contact assembly arranged in the housing and having at least two IDC contacts, each of the plug-in contacts having one IDC contact connected; and
(d) a cable bushing extending through the housing to a region at which at least one stripped region of a continuous SPE cable is guided, the two conductors being contacted in the housing by the IDC contacts of the contact assembly, wherein a first of the two conductors of an SPE cable is connectable to a first of the two plug-in contacts and a second of the two conductors of the SPE cable is connectable to a second of the two plug-in contacts, a T or Y branch being provided with regard to the SPE cable.

6. The SPE plug-in connector according to claim 5, wherein the housing has a T or Y-shaped configuration, the cable bushing extending through the cross-limb of the T-shaped housing, the plug-in side with the plug-in face being arranged at the base limb of the housing.

7. The SPE plug-in connector according to claim 5, wherein the housing has one or more tension relief units for the SPE cable.

8. The SPE plug-in connector according to claim 7, wherein the one or more tension relief units each include a pivotable clip element having a locking hook for locking onto the housing.

9. The SPE plug-in connector according to claim 5, wherein the housing has two housing halves, the contact assembly being arranged in one housing half and a cable manager being arranged in the other housing half.

10. The SPE plug-in connector according to claim 5, wherein the housing includes a narrow side and a main side, a ratio between a width of the narrow side and a height of the main side being in the range of 2:1 to 3:1.
